(19) United States
(12) Patent Application Publication
(10) Pub. No.: US 2022/0156389 A1
(43) Pub. Date: May 19, 2022

(54) SERVICE MANAGEMENT SYSTEM, SERVICE MANAGEMENT METHOD, AND NON-TRANSITORY RECORDING MEDIUM

(71) Applicant: Satoshi Aoki, Kanagawa (JP)

(72) Inventor: Satoshi Aoki, Kanagawa (JP)

(73) Assignee: Ricoh Company, Ltd., Tokyo (JP)

(21) Appl. No.: 17/451,015

(22) Filed: Oct. 15, 2021

(30) Foreign Application Priority Data
Nov. 13, 2020 (JP) 2020-189767

(51) Int. Cl. G06F 21/60; G06F 21/31; H04L 29/08

(52) U.S. Cl. CPC G06F 21/604; G06F 2221/2141; H04L 67/16; G06F 21/31

(57) ABSTRACT

A service management system, a service management method, and a non-transitory recording medium. The service management system in response to a request received from a terminal device of a user who uses a first service provided by a first system, for accessing one or more second services provided by a second system, controls to display on a display of the terminal device, a display screen that includes one or more second services available to the user among the one or more second services for selection by the user, changes contract contents of the second services available to the user according to a change operation on the display screen, and provides the one or more second services to the terminal device according to the contract contents that are changed.

### CROSS-REFERENCE TO RELATED APPLICATIONS

This patent application is based on and claims priority pursuant to 35 U.S.C. § 119(a) to Japanese Patent Application No. 2020-189767, filed on Nov. 13, 2020, in the Japan Patent Office, the entire disclosure of which is hereby incorporated by reference herein.

### BACKGROUND

### Technical Field

The present disclosure relates to a service management system, a service management method, and a non-transitory recording medium.

### Related Art

A known service management system provides an interface for accessing from a first service provided by a first system, a second service provided by a second system.

For example, the service management system issues an authorization token after confirming that both a user and a service of a link source have sufficient authority to execute a service of a link destination in response to an access request from the first system to the second system.

### SUMMARY

Embodiments of the present disclosure describe a service management system, a service management method, and a non-transitory recording medium. The service management system in response to a request received from a terminal device of a user who uses a first service provided by a first system, for accessing one or more second services provided by a second system, controls to display on a display of the terminal device, a display screen that includes one or more second services available to the user among the one or more second services for selection by the user, changes contract contents of the second services available to the user according to a change operation on the display screen, and provides the one or more second services to the terminal device according to the contract contents that are changed.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a block diagram illustrating an example of a system configuration of an information processing system according to embodiments of the present disclosure;

FIG. 2 is a block diagram illustrating an example of a hardware configuration of a computer according to embodiments of the present disclosure;

FIG. 3 is a block diagram illustrating an example of a functional configuration of a service management system according to embodiments of the present disclosure;

FIGS. 4A, 4B, and 4C are diagrams illustrating examples of information managed by the information processing system according to embodiments of the present disclosure;

FIGS. 5A and 5B are diagrams illustrating examples of information managed by the information processing system according to embodiments of the present disclosure;

FIG. 6 is a sequence diagram illustrating an example of a process executed by the information processing system according to a first embodiment of the present disclosure;

FIG. 7 is a sequence diagram illustrating an example of the process executed by the information processing system according to the first embodiment of the present disclosure;

FIGS. 8A and 8B are diagrams illustrating examples of display screens according to the first embodiment of the present disclosure;

FIG. 9 is a diagram illustrating an example of the display screen according to the first embodiment of the present disclosure;

FIG. 10 is a sequence diagram illustrating an example of a process for clearing a license upper limit error according to the first embodiment of the present disclosure;

FIG. 11 is a sequence diagram illustrating another example of a process for clearing a license upper limit error according to the first embodiment of the present disclosure;

FIG. 12 is a sequence diagram illustrating an example of a process executed by the information processing system according to a second embodiment of the present disclosure;

FIG. 13 is a sequence diagram illustrating an example of the process executed by the information processing system according to the second embodiment of the present disclosure; and

FIG. 14 is a diagram illustrating an example of the display screen according to the second embodiment of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

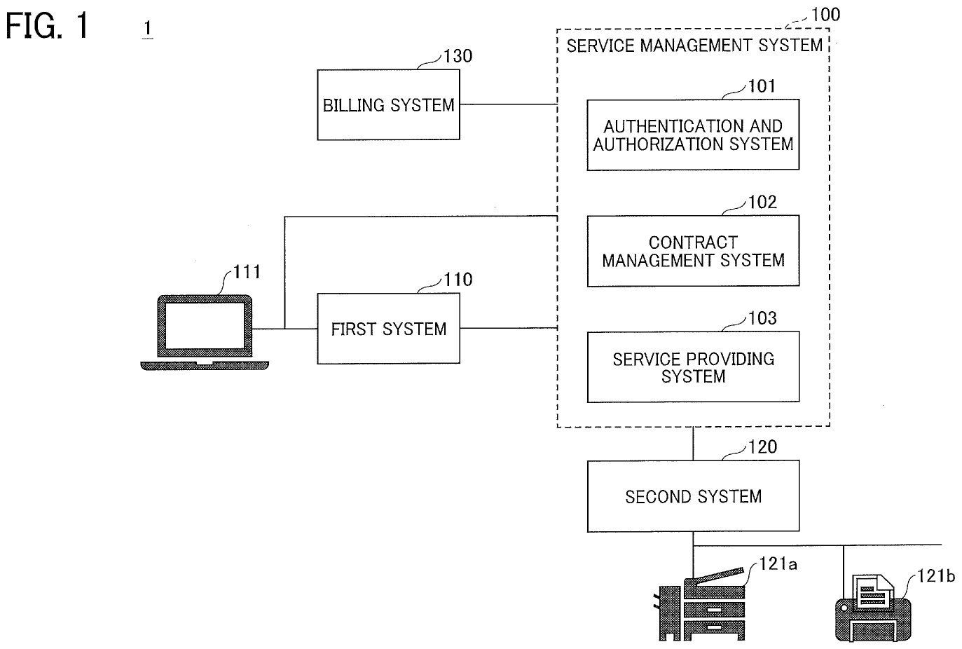

FIG. 1 is a block diagram illustrating an example of a system configuration of an information processing system according to the present embodiment. In the information processing system 1, for example, a service management system 100, a first system 110, a second system 120, a billing system 130, a terminal device 111, and the like are connected to each other so as to be able to communicate with each other through a communication network.

The first system 110 is, for example, an information processing apparatus having a computer configuration, or a system including a plurality of information processing apparatuses. The first system 110 provides by executing a program, one or more first services including a first device management service for managing electronic devices such as image forming apparatuses developed by a plurality of manufacturers.

The terminal device 111 is an information terminal such as a personal computer (PC), a tablet terminal, or a smartphone, which is used by a user who uses the first system. The users of the first system include, for example, a dealer (sales company) that sells the electronic devices such as the image forming apparatuses developed by the plurality of manufacturers and an administrator (administration company) who manages the electronic devices such as the image forming apparatuses developed by the plurality of manufacturers.

The second system 120 is, for example, the information processing apparatus having the computer configuration, or the system including the plurality of information processing apparatuses. The second system 120 provides by executing a program, one or more second services including a second device management service for managing the electronic devices such as the image forming apparatus developed by a specific manufacturer.

In the example of FIG. 1, the second system 120 functions as a device management system that manages a plurality of image forming apparatuses 121a, 121b, etc. The administrator or the like who manages the plurality of image forming apparatuses 121a, 121b, etc., uses the second service provided by the second system 120, for example, to acquire device information, set device information, reboot, analyze a failure, manage maintenance such as firmware update, etc. The management of the second system 120 is not limited to the image forming apparatus and may include the electronic devices developed by a specific manufacturer such as a projector or an interactive whiteboard (IWB) that is an electronic whiteboard capable of intercommunication.

The service management system 100 provides an interface for accessing the second service provided by the second system from the first service provided by the first system. The service management system 100 includes, for example, an authentication and authorization system 101, a contract management system 102, a service providing system 103, and the like.

The authentication and authorization system 101 is, for example, the information processing apparatus having the computer configuration or the system including the plurality of information processing apparatuses and authenticates and authorizes a user who uses the first system. The contract management system 102 is, for example, the information processing apparatus having the computer configuration or the system including the plurality of information processing apparatuses and manages the contract information and the like of the user who uses the first system. The service providing system 103 is, for example, the information processing apparatus having the computer configuration or the system including the plurality of information processing apparatuses. The service providing system 103 provides, for example, the second service provided by the second system 120 to the first service provided by the first system 110 according to contract information of the user who uses the first system.

The billing system 130 is, for example, the information processing apparatus having the computer configuration or the system including the plurality of information processing apparatuses. The billing system 130 charges, for example, a usage fee of the service management system 100 to an operator or the like that operates the first system 110.

With the above configuration, the user who uses the terminal device 111 can use the second service provided by the second system 120 through the first service provided by the first system 110. For example, the user uses the terminal device 111 to perform various maintenance management such as acquisition of device information, setting of device information, reboot, failure analysis, and firmware update of the image forming apparatuses 121a, 121b, etc. managed by the second system 120.

Preferably, the user who uses the terminal device 111 can also use the function of the device management system for managing electronic devices developed by other manufacturers through the first service provided by the first system 110. As a result, the user who uses the first system 110 can maintain and manage various electronic devices developed by the plurality of manufacturers by using the first service provided by the first system 110. Method of using the functions of device management system for managing electronic devices developed by other manufacturers from the first system 110 differs depending on the manufacturer, and is not described here.

In the service management system 100 that provides the interface for accessing the second system from the first system 110, a new service may be added to the second system. In such a case, in a conventional technology the user cannot use the new service unless the user separately accesses a contract change screen or the like to change the contract.

In response to receiving a request for using the second service from the terminal device 111 of the user who uses the first system 110, the service management system 100 according to the present embodiment displays a display screen for selectively displaying one or more services available to the user on the terminal device 111. Further, when the service available to the user is changed by a change operation on the display screen, the service management system 100 changes the contract of the service available to the user.

As a result, when the user wants to use a new service added to the second services, the user can use the new service simply by selecting the new service from the display screen displayed on the terminal device 111.

In addition, for example, when there is an unnecessary service among the services contracted for the second service, the user can cancel the unnecessary service simply by cancelling selection of the unnecessary services displayed on the display screen of the terminal device 111.

As described above, according to the present embodiment, the services available to the user can be easily changed by the service management system 100 that provides the interface that uses the second system 120 from the first system 110.

The system configuration of the information processing system 1 illustrated in FIG. 1 is an example. For example, the second system 120 may be included in the service management system 100. Further, the billing system 130 may be included in the service management system 100. In addition, the first system 110 and the second system 120 may provide services other than the device management service.

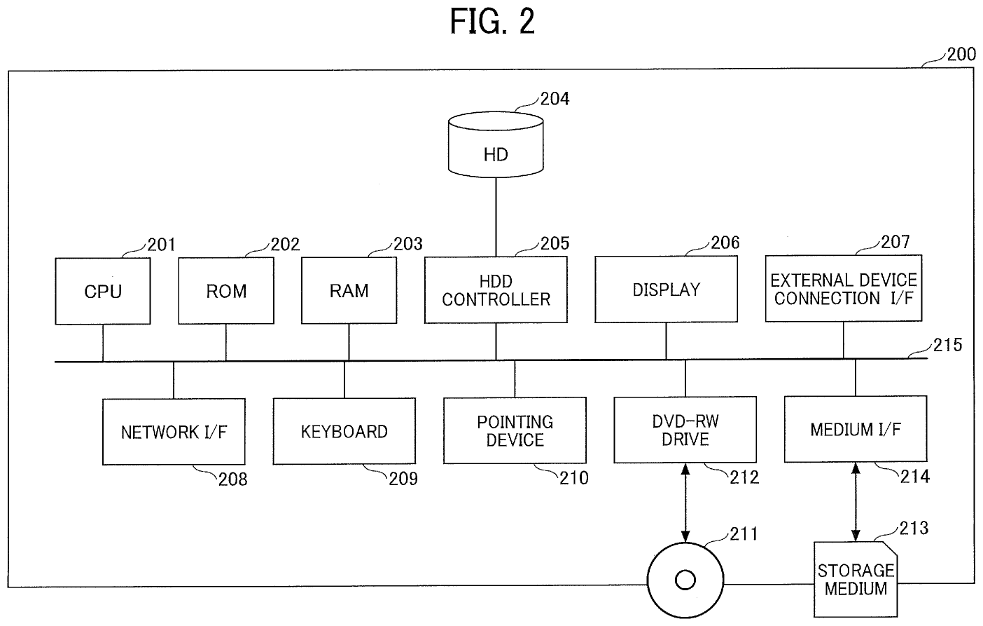

The terminal device 111 of FIG. 1 has, for example, a hardware configuration of the computer 200 as illustrated in FIG. 2. Further, the service management system 100, the authentication and authorization system 101, the contract management system 102, the service providing system 103, the first system 110, the second system 120, the billing system 130, and the like are implemented by one or more computers 200.

FIG. 2 is a block diagram illustrating an example of the hardware configuration of the computer according to the present embodiment. The computer 200 includes, for example, a central processing unit (CPU) 201, a read only memory (ROM) 202, a random access memory (RAM) 203, a hard disk (HD) 204, a hard disk drive (HDD) controller 205, a display 206, an external device connection interface (I/F) 207, a network I/F 208, a keyboard 209, a pointing device 210, a digital versatile disk rewritable (DVD-RW) drive 212, a medium I/F 214, a bus line 215, and the like as illustrated in FIG. 2.

The CPU 201 controls entire operation of the computer 200. The ROM 202 stores programs used for driving the central processing unit (CPU) 201, such as an initial program loader (IPL). The RAM 203 is used as, for example, a work area for the CPU 201. The HD 204 stores, for example, programs such as an operating system (OS), an application, and a device driver, and various data. The HDD controller 205 controls, for example, reading or writing of various data to the HD 204 under control of the CPU 201.

The display 206 displays various information such as a cursor, menu, window, character, or image. The external device connection I/F 207 connects various external devices. The network I/F 208 is an interface for connecting the computer 200 to the communication network. The keyboard 209 is an example of an input device provided with a plurality of keys for allowing a user to input characters, numerals, or various instructions. The pointing device 210 is an example of an input device that allows a user to select or execute a specific instruction, select a target for processing, or move a cursor being displayed.

The DVD-RW drive 212 reads and writes various data from and to a DVD-RW 211, which is an example of a removable storage medium. The DVD-RW 211 is not limited to the DVD-RW and may be another removable recording medium. The medium I/F 214 controls reading or writing (storage) of data to a storage medium 213 such as a flash memory. The bus line 215 includes an address bus, a data bus, various control signals, and the like for electrically connecting each of above components.

Hereinafter, a functional configuration of the service management system 100 according to the present embodiment is described.

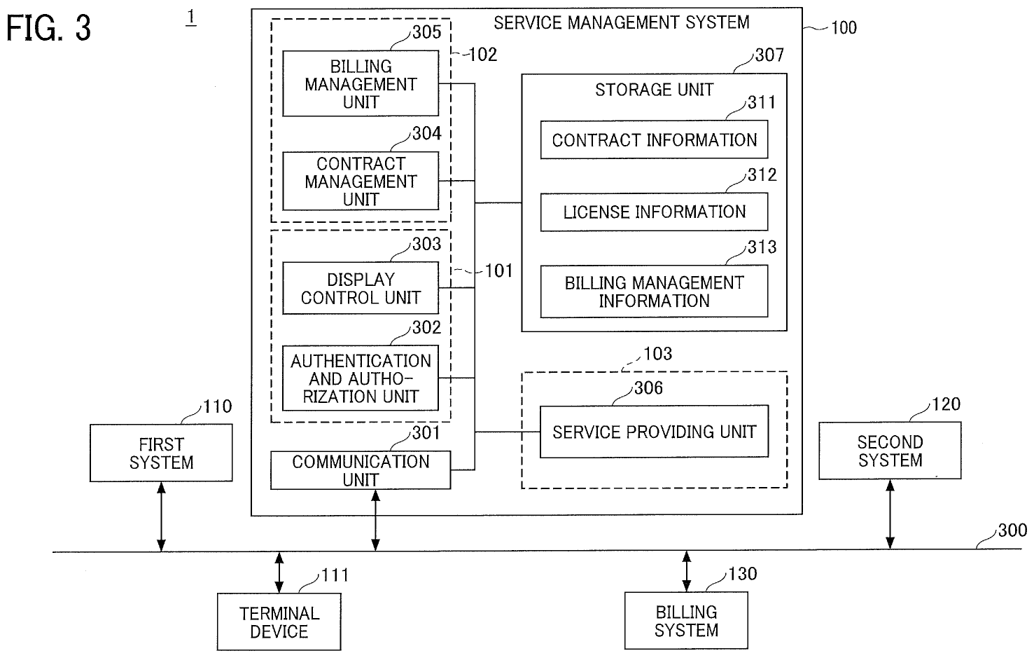

FIG. 3 is a block diagram illustrating an example of a functional configuration of a service management system according to the present embodiment. By executing one or more programs on one or more computers 200, the service management system 100 implements a communication unit 301, an authentication and authorization unit 302, a display control unit 303, a contract management unit 304, a billing management unit 305, a service providing unit 306, the storage unit 307, and the like. Note that at least a part of the above functional units may be implemented by hardware.

The communication unit 301 connects the service management system 100 to, for example, the internet or a communication network 300 such as a local area network (LAN) using the network I/F 208 or the like and communicates with other devices.

The authentication and authorization unit 302 performs an authentication process for authenticating a user who uses the service management system 100, and an authorization process for authorizing the user to use the second service provided by the second system 120 according to the contract information of the user.

The display control unit 303 selectively displays the services available to the user among the second services provided by the second system 120 in response to the request to use the second service from the terminal device 111 on the display screen of the terminal device 111.

The authentication and authorization unit 302 and the display control unit 303 are implemented by the program executed by the authentication and authorization system 101 of FIG. 1 as an example.

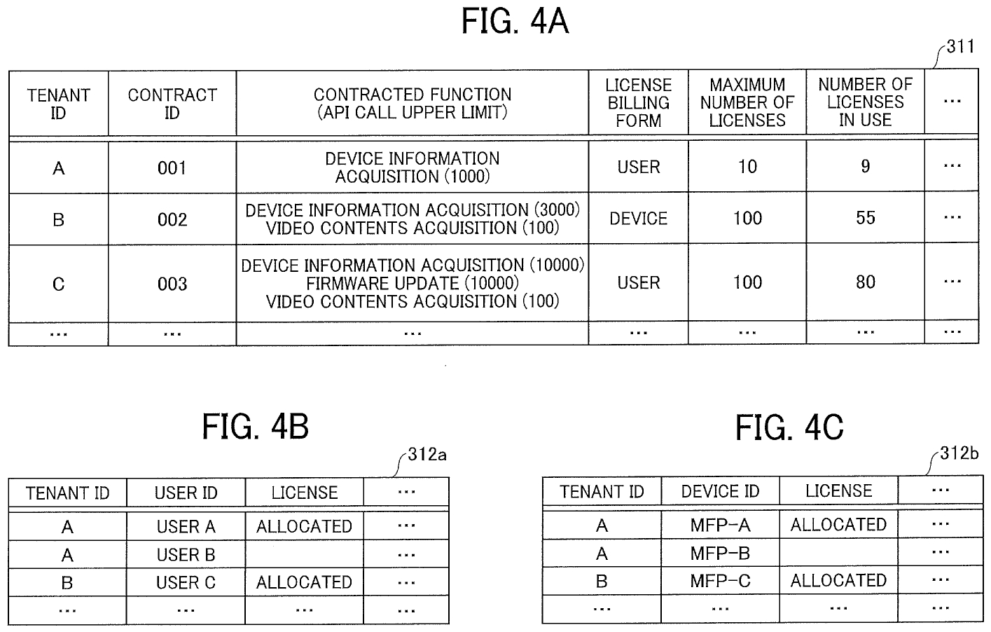

The contract management unit 304 stores and manages contract information including contract contents of the services available to the user in the storage unit 307 and the like. Further, the contract management unit 304 changes the contract contents of the services available to the user according to a change operation on the display screen displayed on the terminal device 111 by the display control unit 303. For example, the contract management unit 304 stores and manages the contract information 311 as illustrated in FIG. 4A and the license information 312 as illustrated in FIG. 4B in the storage unit 307.

FIG. 4A illustrates an example of contract information 311 managed by the contract management unit 304. In the example of FIG. 4A, the contract information 311 includes items such as “tenant ID”, “contract ID”, “contracted function (application programming interface (API) call upper limit)”, “license billing form”, “maximum number of licenses”, and “number of licenses in use”. The “tenant ID” is identification information that identifies a tenant (contractor) such as the dealer (sales company) or the administration company that uses the first system 110. The tenant ID may be a tenant name or the like. The “contract ID” is identification information that identifies the contract.

The “contracted function (API call upper limit)” is information indicating the function (service) contracted by each tenant and an upper limit of the number of times that the API that calls each function can be called. The “contracted function (API call upper limit)” is an example of the contract contents of the service that can be used by the user. The “license billing form” is information indicating whether the number of licenses that can be used by each tenant is limited by the number of users or the number of devices (image forming apparatuses, etc.). The “maximum number of licenses” is information indicating the number of licenses available to each tenant. “Number of licenses in use” is information indicating the number of licenses in use by each tenant.

FIG. 4B illustrates an example of license information 312a when the “license billing form” is the “user”. In the example of FIG. 4B, the license information 312a includes “tenant ID”, “user ID”, and “license” as items. The “tenant ID” is identification information for identifying the tenant and corresponds to the tenant ID in FIG. 4A. The “user ID” is identification information for identifying a user who belongs to the tenant. The “license” is information indicating whether a license has been allocated to each user. In the example of FIG. 4B, the user with the user ID “user A” and the user with the user ID “user B” belongs to the tenant with the tenant ID “A” and the license is allocated only to the user with the user ID “user A”.

FIG. 4C illustrates an example of the license information 312b when the “license billing form” is the “device”. In the example of FIG. 4C, the license information 312c includes “tenant ID”, “device ID”, and “license” information as items. The “tenant ID” is identification information for identifying the tenant. The “device ID” is identification information for identifying a device such as the image forming apparatus to be managed. The “license” is information indicating whether a license has been allocated to each device. In the example of FIG. 4C, the device with the device ID “MFP-A” and the device with the device ID “MFP-B” belongs to the tenant with the tenant ID “A” as management targets, and the license is allocated to the device with the device ID “MFP-A”.

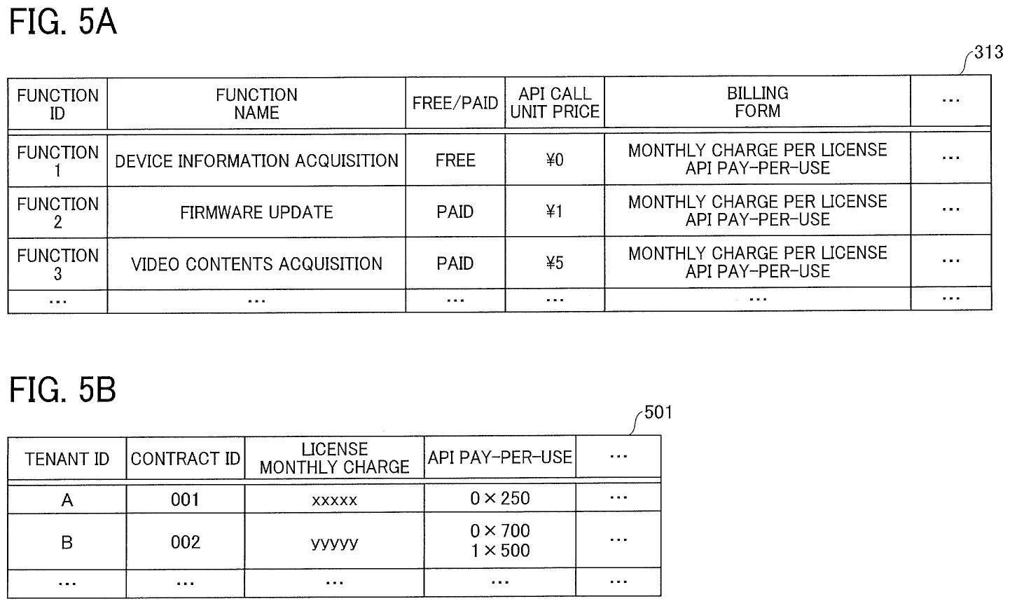

The billing management unit 305 stores and manages, for example, the billing management information 313 as illustrated in FIG. 5A in the storage unit 307 or the like. Further, the billing management unit 305 manages the billing data 501 as illustrated in FIG. 5B, for example, based on the billing management information 313.

FIG. 5A illustrates an example of the billing management information 313 managed by the billing management unit 305. In the example of FIG. 5A, the billing management information 313 includes information such as “function ID”, “function name”, “free/paid”, “API call unit price”, and “billing form” as items. The “function ID” is identification information for identifying each function available in the second service provided by the second system 120. The “function name” is information indicating the name of each function.

The item “free/paid” indicates whether each function is a paid service or a free service. The “API call unit price” indicates the unit price of the API call that calls each function. The “billing form” is information indicating a billing form for each function. For example, in FIG. 5A, the function of the function ID “function 2” is a “paid” service, and 1 yen is charged for each call of the API.

FIG. 5B illustrates an example of the billing data 501 managed by the billing management unit 305. In the example of FIG. 5B, the billing data 501 includes information such as “tenant ID”, “contract ID”, “license monthly charge” and “API pay-per-use” as items. The “tenant ID” is identification information for identifying the tenant. The “contract ID” is identification information for identifying the contract. The billing data 501 includes at least one of the “tenant ID” and the “contract ID”.

The “license monthly charge” is information indicating the monthly license charge (license fee per month) for each tenant. The information item “API pay-per-use” indicates pay-per-use billing based on the number of API calls. In the example of FIG. 5B, as an example, the “API call unit price” of FIG. 5A and the number of times the API is called is stored.

The billing management unit 305 may store and manage the billing data 501 as illustrated in FIG. 5B in the storage unit 307, or in an external storage server or the like accessible from the billing system 130.

The contract management unit 304 and the billing management unit 305 are implemented by, for example, a program executed by the contract management system 102 of FIG. 1.

The service providing unit 306 provides the terminal device 111 (or the first system 110) with the second service provided by the second system 120 according to the contract information 311 managed by the contract management unit 304. For example, in the contract information 311 illustrated in FIG. 4A, when the user who uses the terminal device 111 belongs to the tenant ID “A”, the service providing unit 306 provides the terminal device 111 with the “device information acquisition” function according to the “contracted function (API call upper limit)”. The service providing unit 306 is implemented by, for example, a program executed by the service providing system 103 of FIG. 1.

The storage unit 307 is implemented by, for example, a program executed by the HD 204, the HDD controller 205, and the CPU 201 included in one or more computers 200 included in the service management system 100. The storage unit 307 stores various information such as the contract information 311, the license information 312a and 312b, and the billing management information 313, for example.

The functional configuration of the service management system 100 illustrated in FIG. 3 is an example. For example, the function of the second system 120 may be included in the service management system 100. Further, at least a part of the functions of the billing system 130 may be included in the service management system 100. Further, at least a part of the functions of the service management system 100 may be included in the billing system 130. Further, the storage unit 307 may be implemented by an external server device or the like of the service management system 100.

The terminal device 111 uses the first service provided by the first system 110 by using, for example, a web browser or the like. Further, the terminal device 111 can use the second service provided by the second system 120 through the first system 110 and the service management system 100.

The first system 110 provides the user who uses the terminal device 111 with the first service that includes a plurality of services, including the second service provided by the second system 120. For example, the first system 110 provides the first service that collectively manages electronic devices such as the image forming apparatuses of the plurality of manufacturers by using a plurality of device management systems different for each manufacturer for the user who uses the terminal device 111.

The second system 120 provides the one or more second services including a service for maintaining and managing the electronic devices such as the image forming apparatuses of a specific manufacturer.

The billing system 130 periodically charges the operator or the like that operates the first system 110, the usage fee of the service management system 100 based on, for example, billing data 501 managed by the billing management unit 305 of the service management system 100.

A process of the service management according to the present embodiment is described by exemplifying a plurality of embodiments.

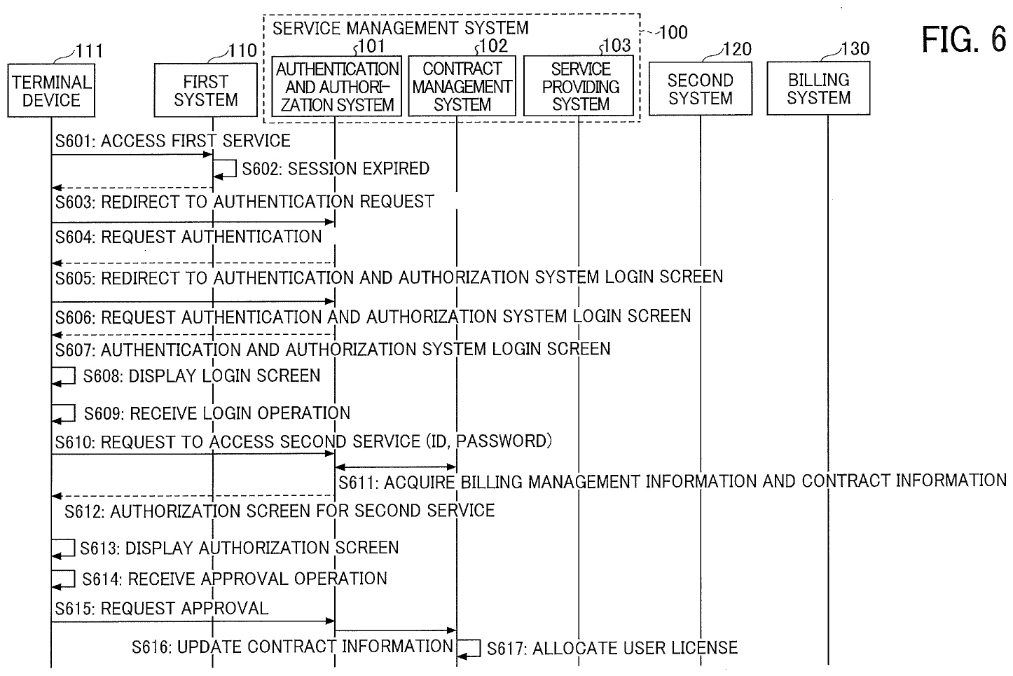

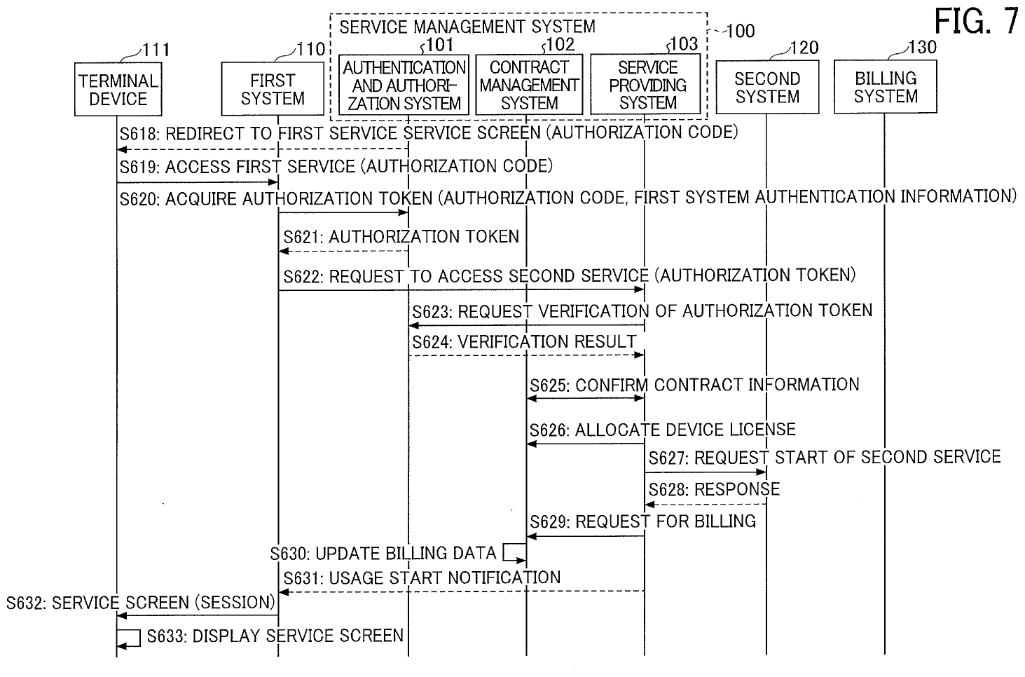

FIGS. 6 and 7 are sequence diagrams illustrating an example of a process executed by the information processing system according to a first embodiment. The process is an example when a user of the first service provided by the first system 110 uses the service management system 100 to access the second service provided by the second system 120.

Here, in order to facilitate illustration, the authentication and authorization unit 302 and the display control unit 303 of FIG. 3 are included in the authentication and authorization system 101, and the contract management unit 304 and the billing management unit 305 are included in the contract management system 102. Similarly, the service providing unit 306 of FIG. 3 is described below assuming that the service providing unit 306 is included in the service providing system 103.

In step S601, the user uses the terminal device 111 to access the first service provided by the first system 110.

In step S602, when there is no cookie session (when the session has expired), the information processing system 1 executes the authentication and authorization processes after step S603. On the other hand, when there is a cookie session, the information processing system 1 executes the process after step S622 in FIG. 7.

In step S603, since the first system 110 has no responsibility for authentication and authorization, the first system 110 instructs the terminal device 111 to redirect and access the authentication and authorization system 101.

In step S604, the terminal device 111 requests authorization from the authentication and authorization system 101 in order to acquire the cookie session required to access the service screen of the first service. In step S605, in response to the authorization request, the authentication and authorization unit 302 of the authentication and authorization system 101 instructs the terminal device 111 to redirect to a login screen of the authentication and authorization system 101.

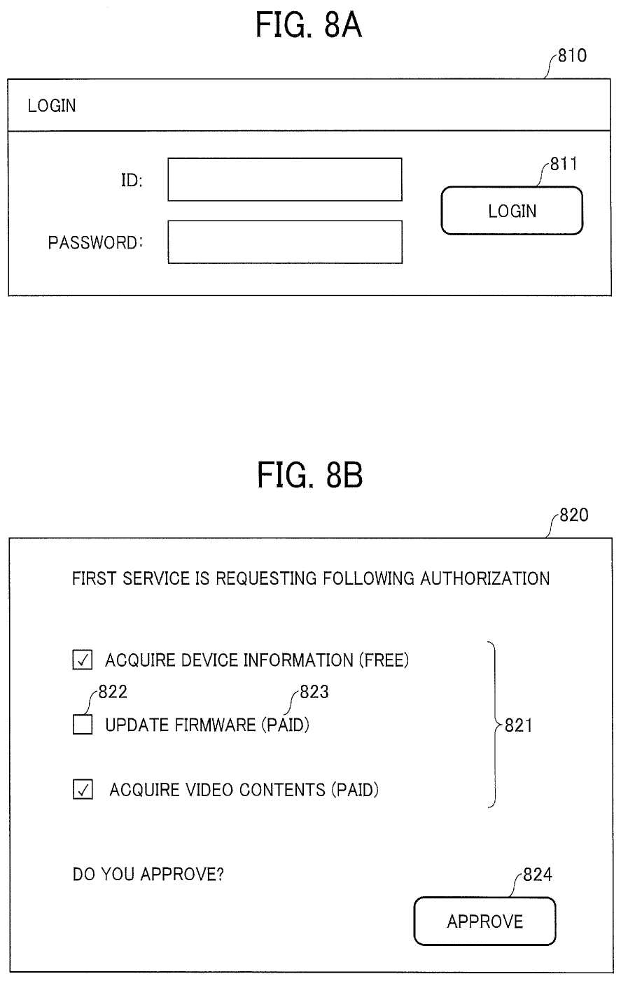

In step S606, the terminal device 111 requests the authentication and authorization system 101 for the login screen. In steps S607 and S608, in response to the request for the login screen, the authentication and authorization unit 302 of the authentication and authorization system 101 causes the terminal device 111 to display, for example, a login screen 810 of the authentication and authorization system 101 as illustrated in FIG. 8A.

In step S609, the terminal device 111 receives a login operation on the login screen 810. For example, the user performs the login operation by entering the user ID and password on the login screen 810 as illustrated in FIG. 8A and selecting a “login” button 811.

In step S610, the terminal device 111 transmits a usage request (login request) requesting the use of the second service provided by the second system 120 to the authentication and authorization system 101. When the login is successful, the authentication and authorization system 101 executes the processes of steps S611 and S612. On the other hand, when the login fails, the authentication and authorization unit 302 of the authentication and authorization system 101 returns an error to the terminal device 111 and requests the login operation again.

In step S611, the display control unit 303 of the authentication and authorization system 101 receives, for example, the billing management information 313 as illustrated in FIG. 5A and the contract information 311 as illustrated in FIG. 4A from the contract management system 102. In steps S612 and S613, the display control unit 303 causes the terminal device 111 to display an authorization screen 820 as illustrated in FIG. 8B, for example, based on the acquired billing management information 313 and the contract information 311.

FIG. 8B illustrates an example of the authorization screen 820 displayed on the terminal device 111 by the display control unit 303 of the authentication and authorization system 101. In the example of FIG. 8B, one or more services 821 that can be used by the user among the second services provided by the second system 120, are displayed in a selectable manner on the authorization screen 820. The display control unit 303 displays, for example, the name of the services 821 that can be used by the user on the authorization screen 820 based on the information of the “function name” of the billing management information 313 as illustrated in FIG. 5A. Further, the display control unit 303 checks a check box 822 of the contracted function based on the information of the “contracted function (API call upper limit)” of the contract information 311 as illustrated in FIG. 4A, for example.

For example, when the user wants to enable a firmware update service, the user enables the service by selecting the check box 822 corresponding to “update firmware” on the authorization screen 820 illustrated in FIG. 8B. In addition, the user can disable an unnecessary service by deselecting the check box 822 corresponding to the unnecessary service.

Preferably, the display control unit 303 displays information 823 indicating whether each of the services 821 available to the user is a paid or free service on the authorization screen 820 based on the “free/paid” information of the billing management information 313 as illustrated in FIG. 5A. Further, when the information indicating that the service is the paid service is clicked, the display control unit 303 may display a price of the service based on the information of the “API unit price” of the billing management information 313 as illustrated in FIG. 5A.

The user can perform an approval operation by selecting the “approval” button 824 on the authorization screen 820.

When the terminal device 111 receives the approval operation by the user in step S614, the terminal device 111 requests the authentication and authorization system 101 for authorization in step S615. Here, since the user has already logged in, in step S616, the display control unit 303 accepts the selection operation on the authorization screen 820 and updates the contract information 311 managed by the contract management system 102. For example, when the check box 822 corresponding to “update firmware” is selected on the authorization screen 820 as illustrated in FIG. 8B, the display control unit 303 notifies the contract management system 102 of the selection. In response to the notification of the selection, the contract management unit 304 of the contract management system 102 adds “firmware update” to the “contracted function (API call upper limit)” column of the contract information 311 as illustrated in FIG. 4A, for example. The API call upper limit value may be set to a default value in advance according to, for example, the number of users belonging to the tenant, the number of devices, and the like.

In step S617, the contract management unit 304 of the contract management system 102 allocates a license to the user of the terminal device 111. For example, the contract management unit 304 refers to the license information 312a as illustrated in FIG. 4B, and when the license is not allocated to the user, the data in the “license” column is changed to “allocated”. When the license billing form is set to the “device”, the contract management unit 304 may omit the process of step S617.

In step S618 of FIG. 7, the authentication and authorization unit 302 of the authentication and authorization system 101 instructs the terminal device 111 to redirect to the service screen of the first service and notify the authorization code that is valid for a certain period of time.

In step S619, the terminal device 111 accesses the first service provided by the first system 110 by using the authorization code notified from the authentication and authorization system 101.

In steps S620 and S621, the first system acquires from the authentication and authorization system 101, the authorization token required for using the second service (web API call) provided by the second system 120 using the authorization code received from the terminal device 111.

In step S622, the first system 110 requests the service providing system 103 to start using the second service provided by the second system 120 by using the acquired authorization token.

In steps S623 and S624, the service providing unit 306 of the service providing system 103 verifies the authorization token received from the first system 110 by using the authentication and authorization system 101. Here, when the authorization token received from the first system 110 is valid, the service providing unit 306 executes the process of step S625. On the other hand, when the authorization token received from the first system 110 is invalid, the service providing unit 306 notifies the first system 110 that the authorization token has expired.

In steps S625 and S626, the service providing unit 306 of the service providing system 103 confirms the contract information 311 and the license information 312 managed by the contract management system 102, and when necessary, allocates device license to the device (for example, the electronic device such as the image forming apparatus or the like). For example, the service providing unit 306 refers to the license information 312b as illustrated in FIG. 4C, and when the license is not allocated to the device ID corresponding to the tenant ID of the tenant to which the user belongs, the service providing unit 306 updates the data in the “license” column to “allocated”.

When the license billing form is set to “user”, the service providing unit 306 may omit the process of steps S625, and S626.

In steps S627 and S628, the service providing unit 306 of the service providing system 103 requests the second system 120 to start the second service by using the web API provided by the second system 120.

In step S629, the service providing unit 306 of the service providing system 103 requests the contract management system 102 to charge the fee using the web API of the second system 120. In step S630, in response to the request, the billing management unit 305 of the contract management system 102 updates the number of API usages of the “API pay-per-use billing” of the billing data 501 as illustrated in FIG. 5B, for example.

When the billing method is not pay-per-use, or when the web API used is free of charge, the service providing unit 306 may omit the process of step S629.

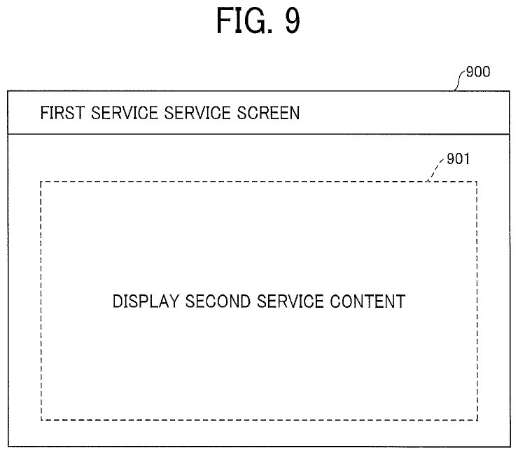

In step S631, the service providing unit 306 of the service providing system 103 notifies the first system 110 of the start of use of the second service. In steps S632 and S633, in response to the notification, the first system 110 causes the terminal device 111 to display a service screen 900 as illustrated in FIG. 9, for example.

FIG. 9 illustrates an example of the service screen 900 of the first service displayed by the terminal device 111 in step S633 of FIG. 7. Service contents 901 (for example, device information acquisition, firmware update, video content acquisition, etc.) of the second service provided by the second system 120 is displayed on the service screen 900.

As described above, the user can easily use the newly added service, change the contract contents, etc. simply by performing the authorization operation on the authorization screen 820 as illustrated in FIG. 8B, for example.

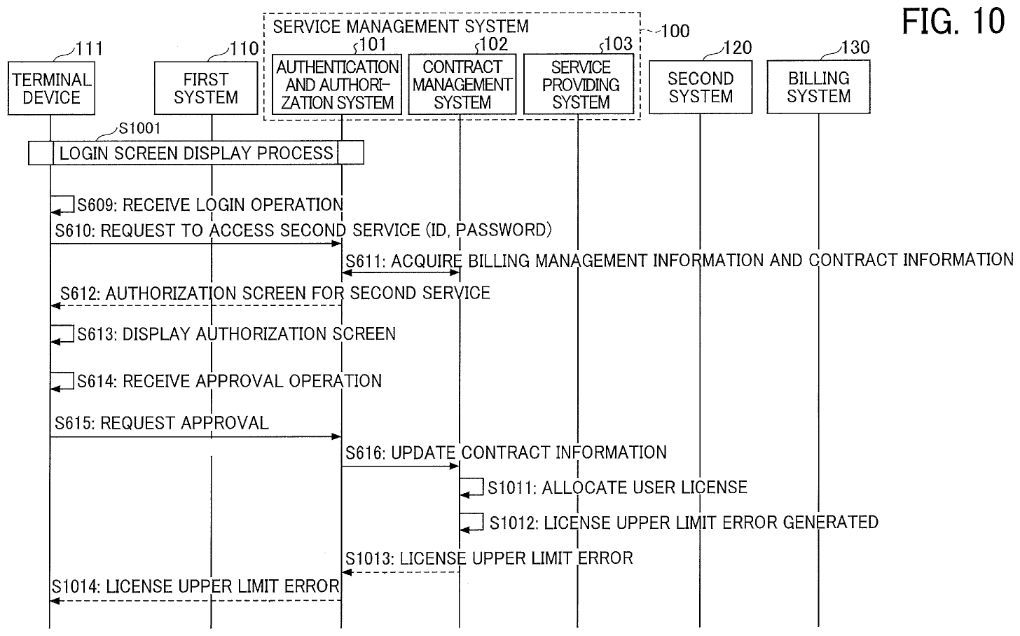

FIG. 10 is a sequence diagram illustrating an example of a process for clearing a license upper limit error according to the first embodiment of the present disclosure. Specifically, an example of the process when the number of licenses allocated to the user exceeds the “maximum number of licenses” in the contract information 311 as illustrated in FIG. 4A is described.

In step S1001, the information processing system 1 executes, for example, a login screen display process as illustrated in steps S601 to S608 of FIG. 6.

In step S609, the terminal device 111 receives the login operation on the login screen 810. In response to the login operation, in step S610, the terminal device 111 transmits a request to use the second service provided by the second system 120 to the authentication and authorization system 101.

In step S611, the display control unit 303 of the authentication and authorization system 101 acquires the billing management information 313 and the contract information 311 from the contract management system 102. In steps S612 and S613, the display control unit 303 causes the terminal device 111 to display the authorization screen 820 as illustrated in FIG. 8B, for example, based on the acquired billing management information 313 and the contract information 311.

When the terminal device 111 receives the approval operation by the user in step S614, the terminal device 111 requests the authentication and authorization system 101 for authorization in step S615. In step S616, in response to the approval operation, the display control unit 303 updates the contract information 311 managed by the contract management system 102 according to the selection operation on the authorization screen 820.

In step S1011, the contract management unit 304 of the contract management system 102 allocates the license to the user of the terminal device 111.

Here, if the number of user licenses exceeds the “maximum number of licenses” of the contract information 311 as illustrated in FIG. 4A and the user license cannot be allocated to the user, the contract management unit 304 causes the license limit error in step S1012.

In steps S1013 and S1014, the contract management unit 304 of the contract management system 102 notifies the terminal device 111 of the license upper limit error through the first system 110, and for example, cancels the execution of the processing of step S618 of FIG. 7.

By the above process, the administrator or the like can control the contract information 311 so that the user license is not allocated indefinitely by setting the upper limit of the number of user licenses in the contract information 311 in advance.

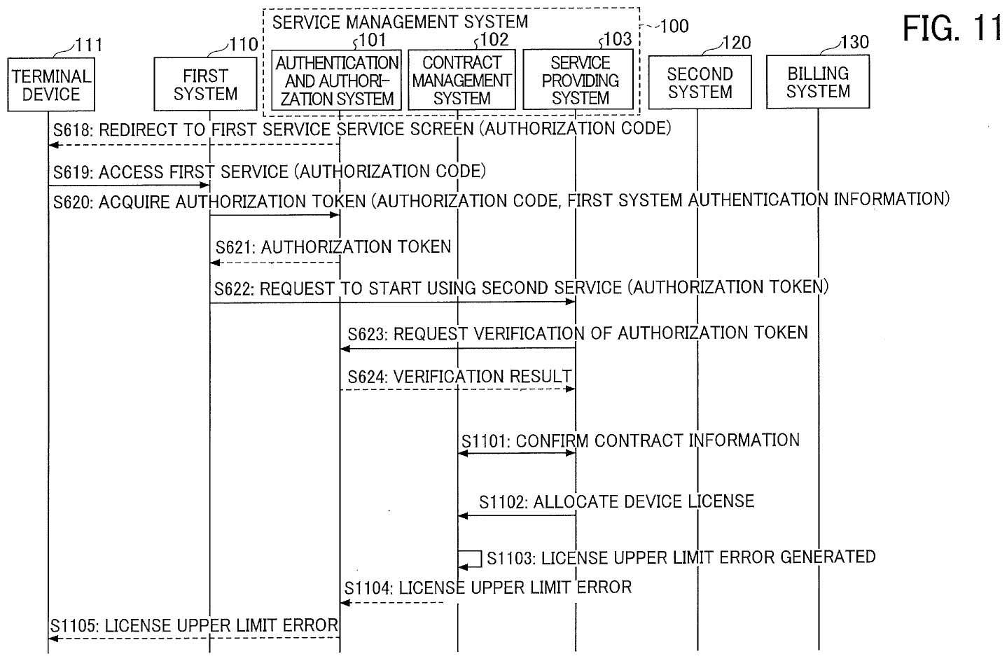

FIG. 11 is a sequence diagram illustrating another example of the process for clearing the license upper limit error according to the first embodiment. FIG. 11 illustrates an example of the process when the number of licenses allocated to the device exceeds the “maximum number of licenses” in the contract information 311 as illustrated in FIG. 4A.

It is assumed that the process of steps S601 to S617 of FIG. 6 have already been executed at the start of the process illustrated in FIG. 11. Further, since the process of steps S618 to S624 of FIG. 11 are the same as the process of steps S618 to S624 described with reference to FIG. 7, the differences from the process described with reference to FIG. 7 is mainly described here.

In steps S1101 and S1102, the service providing unit 306 of the service providing system 103 confirms the contract information 311 and the license information 312 managed by the contract management system 102, and when necessary, allocates device license to the device (for example, the electronic device such as the image forming apparatus or the like).

In step S1103, when the number of device licenses exceeds the “maximum number of licenses” of the contract information 311 as illustrated in FIG. 4A and the device license cannot be allocated to the device, the contract management unit 304 causes the license limit error.

In this case, in steps S1104 and S1105, the contract management unit 304 of the contract management system 102 notifies the terminal device 111 of the license upper limit error through the first system 110, and for example, cancels the execution of the processing of step S627 of FIG. 7.

By the above process, the administrator or the like can manage the contract information 311 so that the device license is not assigned indefinitely by setting the upper limit of the number of device licenses in the contract information 311 in advance.

As described above, according to the present embodiment, the services available to the user can be easily changed by the service management system 100 that provides the interface that uses the second system 120 from the first system 110.

In a second embodiment, an example of a process to display the authorization screen 820 as illustrated in FIG. 8B when a new service is added to the second service provided by the second system 120 is described.

The system configuration, hardware configuration, and functional configuration of the information processing system 1 according to the second embodiment may be the same as the first embodiment.

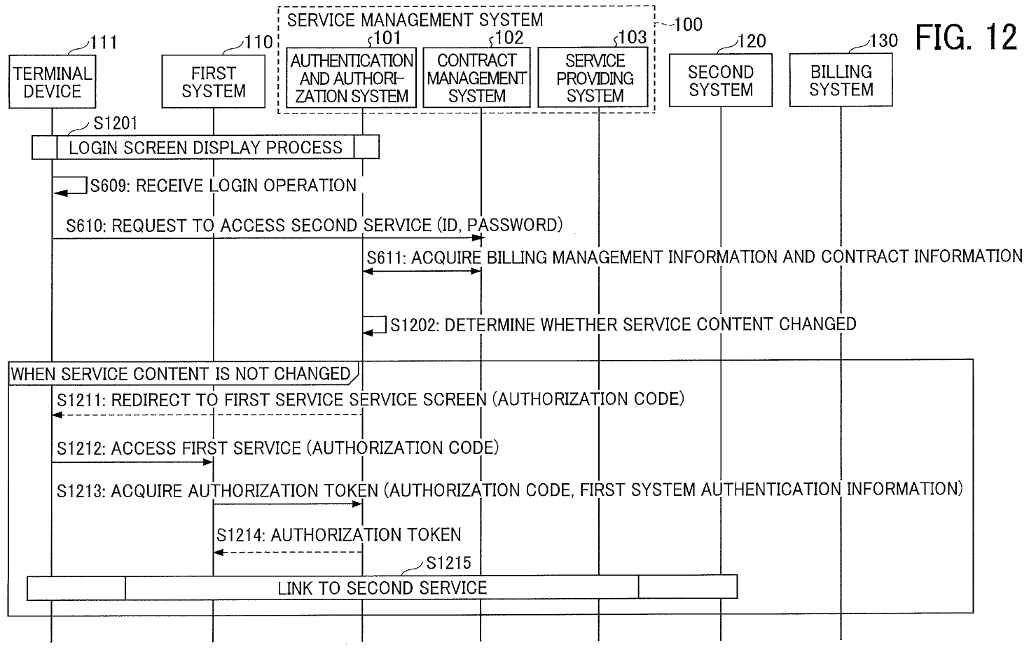

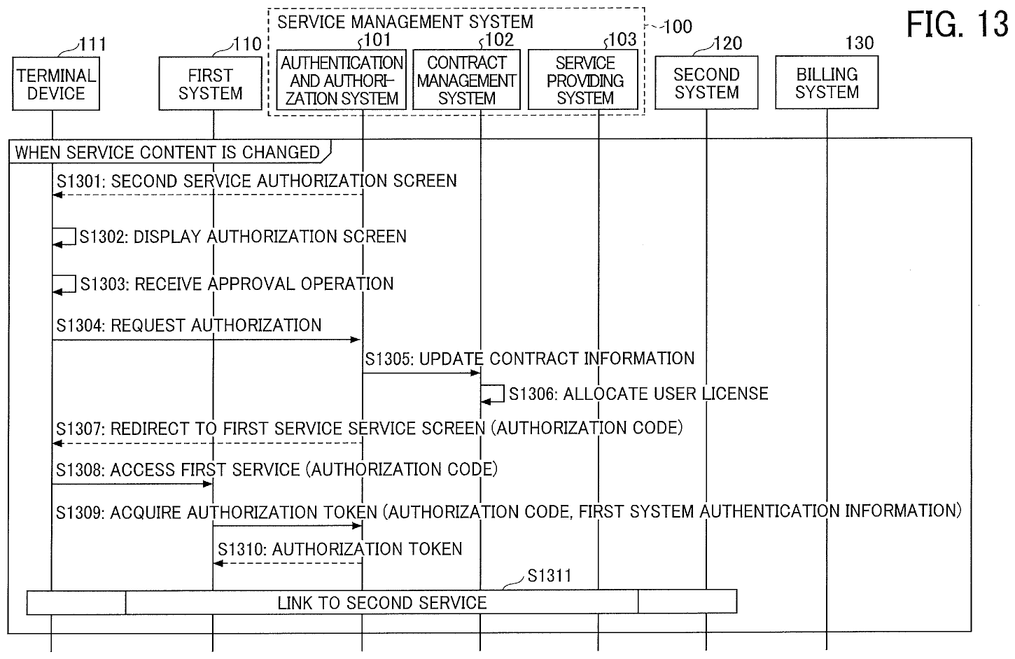

FIGS. 12 and 13 are sequence diagrams illustrating an example of the process executed by the information processing system according to the second embodiment of the present disclosure. Since the basic process is the same as the process executed by the information processing system according to the first embodiment described with reference to FIGS. 6 and 7, the differences from the first embodiment is mainly described. Further, detailed description of the same processing as in the first embodiment is omitted.

In step S1201, the information processing system 1 executes, for example, the login screen display process as illustrated in steps S601 to S608 of FIG. 6.

In step S609, the terminal device 111 receives the login operation on the login screen 810. In step S610, in response to the login operation, the terminal device 111 transmits a request to use the second service provided by the second system 120 to the authentication and authorization system 101.

In step S611, the display control unit 303 of the authentication and authorization system 101 receives, for example, the billing management information 313 as illustrated in FIG. 5A and the contract information 311 as illustrated in FIG. 4A from the contract management system 102.

In step S1202, the display control unit 303 of the authentication and authorization system 101 determines whether there is a change in the service contents of the second service provided by the second system 120. When the service contents are not changed, the information processing system 1 executes the processes illustrated in steps S1211 to S1215. On the other hand, when there is a change in the service contents, the information processing system 1 executes the process illustrated in steps S1301 to S1311 of FIG. 13.

In step S1211, when the service contents are not changed, the display control unit 303 of the authentication and authorization system 101 stops the process of displaying the authorization screen 820 as illustrated in FIG. 8B, for example, on the terminal device 111. Further, the authentication and authorization unit 302 of the authentication and authorization system 101 instructs the terminal device 111 to redirect to the service screen of the first service and notifies the authorization code valid for a certain period of time.

In step S1212, the terminal device 111 accesses the first service provided by the first system 110 by using the authorization code notified from the authentication and authorization system 101.

In steps S1213 and S1214, the first system 110 acquires from the authentication and authorization system 101, the authorization token required for using the second service (web API call) provided by the second system 120 using the authorization code received from the terminal device 111.

In step S1215, the information processing system 1 executes, for example, a linking process with the second system 120 as illustrated in steps S622 to S633 of FIG. 7.

By the above processing, the service management system 100 can skip the processing of displaying the authorization screen 820 on the terminal device 111 when there is no change in the service contents of the second service.

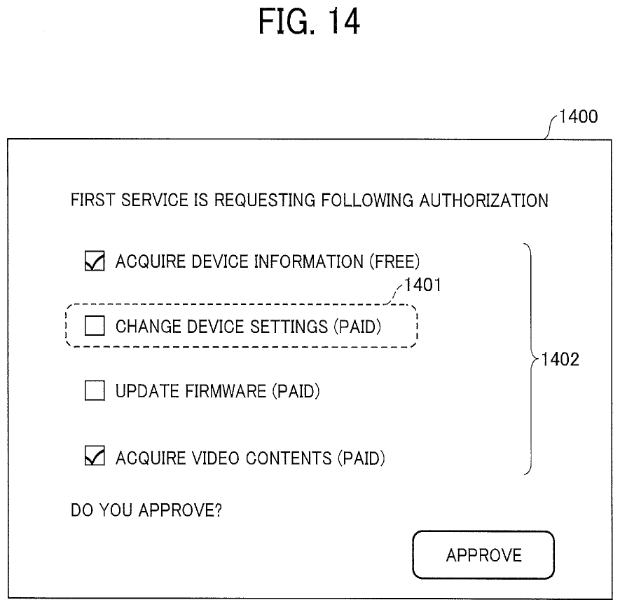

On the other hand, when there is a change in the service contents, in steps S1301 and S1302 of FIG. 13, the display control unit 303 displays, for example, the authorization screen 1400 as illustrated in FIG. 14 on the terminal device 111 based on the acquired billing management information 313 and the contract information 311.

FIG. 14 illustrates an example of the authorization screen 1400 displayed on the terminal device 111 by the display control unit 303 of the authentication and authorization system 101. In the authorization screen 1400 illustrated in FIG. 14, a service 1401 newly added to the second service is displayed in a selectable manner in addition to the authorization screen 820 described in FIG. 8B. The display control unit 303 displays, for example, the name of the service 1402 available to the user on the authorization screen 1400 based on the information of the “function name” of the billing management information 313 as illustrated in FIG. 5A. Further, the display control unit 303 checks a check box 822 of the contracted function based on the information of the “contracted function (API call upper limit)” of the contract information 311 as illustrated in FIG. 4A, for example.

In response to the receiving of approval operation by the user in step S1303, the terminal device 111 requests the authentication and authorization system 101 for authorization in step S1304. In step S1305, since the user has already logged in, the display control unit 303 accepts the selection operation on the authorization screen 820 and updates the contract information 311 managed by the contract management system 102.

In step S1306, the contract management unit 304 of the contract management system 102 allocates a user license to the user of the terminal device 111, when necessary.

In step S1307, the authentication and authorization unit 302 of the authentication and authorization system 101 instructs the terminal device 111 to redirect to the service screen of the first service and notifies the authorization code valid for a certain period of time.

In step S1308, the terminal device 111 accesses the first service provided by the first system 110 by using the authorization code notified from the authentication and authorization system 101.

In steps S1309 and S1310, the first system 110 acquires from the authentication and authorization system 101, the authorization token required for using the second service (web API call) provided by the second system 120 using the authorization code received from the terminal device 111.

In step S1311, the information processing system 1 executes the linking process with the second system 120 as illustrated, for example, in steps S622 to S633 of FIG. 7.

By the above processing, the service management system 100 can recommend the use of the newly added service to the user when the service contents of the second service are changed. Further, for example, on the authorization screen 1400 as illustrated in FIG. 14, the user can easily use (contract) the newly added service without separately accessing the contract change screen or the like to change the contract.

As described above, according to the present embodiment, the services available to the user can be easily changed by the service management system 100 that provides the interface for accessing the second system 120 from the first system 110.

Note that each of the above embodiments is an example, and various modifications or applications are possible. For example, the authorization screen 820 illustrated in FIG. 8B and the authorization screen 1400 illustrated in FIG. 14 are examples of the display screens that the display control unit 303 causes the terminal device 111 to display the services available to the user in the selectable manner. For example, the display control unit 303 may display the services available to the user on the service selection screen in a selectable manner, instead of the authorization screen, and receive a user's selection operation by pressing the “select” button or the like. Further, the display control unit 303 may display the services that can be used by the user on the change screen of the available services instead of the authorization screen so that the user can select the services and presses the “change” button or the like to perform the selection operation by the user.

The apparatuses or devices described in one or more embodiments are just one example of plural computing environments that implement the one or more embodiments disclosed herein. In certain embodiments, the service management system 100 includes a plurality of computing devices, such as a server cluster. The plurality of computing devices is configured to communicate with one another through any type of communication link, including a network, shared memory, etc., and perform the processes disclosed herein.

Further, the service management system 100 and the second system 120 can be configured to share the disclosed processing steps, for example, the processing illustrated in FIGS. 6 to 7 and FIGS. 10 to 13, in various combinations. For example, a process executed by a given unit may be executed by the service management system 100. Similarly, the function of a given unit can be performed by the second system 120. Further, each element of the service management system and the second system 120 may be integrated into one server device or may be divided into a plurality of devices.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

1. A service management system comprising:
circuitry configured to:
in response to a request, received from a terminal device of a user who uses a first service provided by a first system, for accessing one or more second services provided by a second system, control to display on a display of the terminal device, a display screen that includes one or more second services available to the user among the one or more second services for selection by the user;
change contract contents of the second services available to the user according to a change operation on the display screen; and
provide the one or more second services to the terminal device according to the contract contents that are changed.

2. The service management system of claim 1, wherein
the circuitry is further configured to:
determine whether there is a change in service contents of the one or more second services, in response to receiving a request for accessing the one or more second services from the terminal device; and
control to display the display screen on the display of the terminal device, in response to a determination that there is the change in the service contents of the one or more second services.

3. The service management system of claim 1, wherein
the display screen includes an authorization screen that receives an authorization operation for the services available to the user.

4. The service management system of claim 1, wherein
the circuitry is further configured to:
determine whether each service included in the one or more second services is a paid service or a free service; and
control to display on the display of the terminal device, information indicating whether each service included in the one or more second services is the paid service or the free service on the display screen.

5. The service management system of claim 4, wherein
the circuitry is further configured to update information indicating a usage of the paid service with the user according to the contract contents of the user.

6. The service management system of claim 1, wherein
the circuitry is further configured to:
determine maximum number of users allowed to access each of the one or more second services; and
limit the access to each of the one or more second services by the users when the number of users accessing each of the second services exceeds the maximum number of users allowed to access each of the one or more second services.

7. The service management system of claim 1, wherein
the circuitry is further configured to:
determine maximum number of devices allowed to access each of the one or more second services; and
limit the access to each of the one or more second services by the devices when the number of devices accessing each of the one or more second services exceeds the maximum number of devices allowed to access each of the one or more second services.

8. The service management system of claim 1, wherein
the first service includes a first device management service for managing electronic devices developed by a plurality of manufacturers; and
the one or more second services include a second device management service for managing electronic devices developed by one of the plurality of manufacturers.

9. A service management method, comprising:
in response to a request received from a terminal device of a user who uses a first service provided by a first system, for accessing one or more second services provided by a second system, controlling to display on a display of the terminal device, a display screen that includes one or more second services among the one or more second services for selection by the user;
changing contract contents of the second services available to the user according to a change operation on the display screen; and
providing the one or more second services to the terminal device according to the contract contents that are changed.

10. A non-transitory recording medium storing a plurality of instructions which, when executed by one or more processors, causes the processors to perform a service management method comprising:
in response to a request received from a terminal device of a user who uses a first service provided by a first system, for accessing one or more second services provided by a second system, controlling to display on a display of the terminal device, a display screen that includes one or more second services among the one or more second services for selection by the user;
changing contract contents of the second services available to the user according to a change operation on the display screen; and
providing the one or more second services to the terminal device according to the contract contents that are changed.
